(19) United States
(12) Patent Application Publication
(10) Pub. No.: US 2006/0047524 A1
(43) Pub. Date: Mar. 2, 2006

(54) Method of Opportunity Solicitation, Referral, and Data Management

(76) Inventors: Mark Robert Lambert, Park City, UT (US); David G. Erickson, Salt Lake City, UT (US); William H. Righter, Portland, OR (US)

Correspondence Address: SCOTT A. NELSON, 1740 SW LOBELIA, PORTLAND, OR, 97219, US

(21) Appl. No.: 10/711,110

(22) Filed: Aug. 24, 2004

(51) Int. Cl. G06Q 99/00; H04L 9/00; H04M 3/51

(52) U.S. Cl. 705/1; 705/11; 705/80

(57) ABSTRACT

A method of identifying and expanding a database of potential employees from a predetermined pool of prescreened candidates supplied by the initiating entity. The predetermined pool being the first of infinite generations of prescreened candidates who may be rewarded for referring other qualified candidates. The initiating entity will create and maintain the screening criteria to minimize the number of unqualified resources and the costs associated with this number, and maximize the value of the resources expended on the recruitment endeavor. The resulting expanded database can be used to generate focus groups that may have similar interests based on parameters such as education, geographic location, economic status and other parameters.

### TECHNICAL FIELD

The invention generally relates to Internet and network-based methods of sourcing, screening and referring potential employees and the management of those resources.

### BACKGROUND ART

Over the past several decades there has been a change in the waycompanies and their employees have perceived their particular roles in society. In the past companies were expected to grow and maintain relationships with their employees. Employees looked to the companies they chose to work for for professional growth and stability during their careers and during their retirements. Companies generally promoted from within, encouraged apprenticeship programs, maintained retirement programs and pensions, all of which encouraged employees to stay with that company for the duration of their career. With the acceleration of technologies and globalization of markets, the companies and therefore the employees have had to adapt to a job market that can change very quickly.

To stay competitive, companies have had to locate and hire resources that need a minimum amount of training and are usually specialized in the field in which they are expected to function. Companies can seldom afford to hire new recruits and expect them to become cost efficient in a time frame that will grant the company maximum return on the resources spent to train that new employee. If that new employee fails to become proficient in the task they were hired for, the company, in effect, has to start over with another resource, losing time and money in a very competitive market.

To increase a company's chance of locating and recruiting the correct candidate for the correct position, companies have historically used several methods, each of which had strengths and weaknesses particular to the application it was used for. One such method was advertising a position in printed mass media, such as a newspaper or trade magazine. Advantages of this method were that it was able to reach a large audience and the cost of the ad was relatively inexpensive. The disadvantages were that it did reach a large audience and in times of economic slowdown, the hiring company may receive hundreds or even thousands of applications of which the vast majority where not qualified for the position. Each application needed to be screened and evaluated incurring a huge amount of time and resources spent by the hiring entity.

Another method of recruitment was the use of “headhunters” or hiring services that acted as a pre-screening consultant on a company's behalf. One of the headhunter's methods of sourcing potential candidates would be by word of mouth or referrals. The benefits of this method would be that the company would only receive qualified, or at least a narrowed list of potential employees after which they could select the most qualified for further interviews or information. The disadvantages are that the pool of potential candidates is only as large as the headhunters' database. The company of course could hire as many headhunters as it deemed necessary but the cost in dollars and time would again be a limiting factor.

An offshoot of the headhunter recruitment model is a method known as using a “inders fee”. The finders' fee would usually be a monetary reward to current employees who would refer an acquaintance who may or may not be qualified for the offered position. If the referral were to obtain the position, the referrer would be rewarded a predetermined amount. Disadvantages being the limited resource pool and advantages being the potential employee being referred would in effect are pre-screened. Further advantages to this method would be that the person being referred would be familiar with the company, probably being at least briefed with aspects of the company from the referrer. Also the referring party, who would most likely be a present employee of the company, would only want to recommend a qualified person, in fear of having anyone who may potentially not work out, reflect poorly upon themselves. As a result of the disadvantages and advantages of the before mentioned methods of recruitment, the problems such as time, cost and effort present obstacles in a company's' path towards profitability. At present, there are no known mechanisms that can elevate all of the problems.

### SUMMARY OF THE INVENTION

It is the object of the present invention to provide for a method and system that can be used to find, manage and reward a network of resources and to provide a hiring entity access to this network, therefore reducing the hiring entities costs, resources and duration of time in locating qualified candidates.

According to one aspect of this invention, a method for finding resources includes sending an opportunity description to a qualified, potential resource and, in response, offering a reward for a forwarding of the opportunity description to another qualified resource. The results of this aspect are that the hiring entity will minimize the likelihood that unqualified candidates will respond to the original position description. Instead, the first recipient may opt to forward the description to acquaintances that many have the required qualifications or know someone else who does, and in turn, referring that person and claiming a reward. The cost of pre-screening potential employees will be passed on to those who may benefit by successfully referring the chosen candidate. The pool of potential employees may grow exponentially due to the fact that one person may submit as many references that are known to him or her what would qualify for the position offered.

Another aspect of the invention is to greatly reduce the inefficiencies found in the current method of locating and identifying potential employees. Reducing these inefficiencies can greatly decrease the likelihood that resources will be spent on applicants who are not qualified or are submitting applications only to fulfill obligations for unemployment claims or other ulterior motives.

Another aspect of the invention will be the creation of specific resource databases that may assist future clients in identifying potential employees in fields that may be new to that company. Also the resource databases will be able to be manipulated to provide resources specific to a geographic region, further assisting the hiring entity for location specific criteria.

### BRIEF DESCRIPTION OF THE DRAWINGS

An embodiment of the invention is shown in the drawing, with preferred manners described in the detailed description below, it being understood, however, that the invention is not limited to the precise arrangements and instrumentalities shown and/or described.

FIG. 1 is a block diagram of a system wherein a hiring entity, can utilize a managing entity to facilitate resource location and management, and the resource may realize multi-level awards for enlarging the database accordingly.

### DETAILED DESCRIPTION OF THE PREFERRED EMBODIMENTS

The method and system described herein provides resource location and identification to hiring entities that seek to minimize the costs and resources historically associated with the hiring process. The method will be described in the context of an Internet based networking system. The Internet can act as an accelerator of the “word of mouth” or “grapevine” method of sourcing potential employees. In the same manner that gossip and hearsay may propagate throughout a network of friends at a social event, the described invention will work to link associates with common interests and qualifications by an efficient, expedient and low cost system that also provides rewards to the participants.

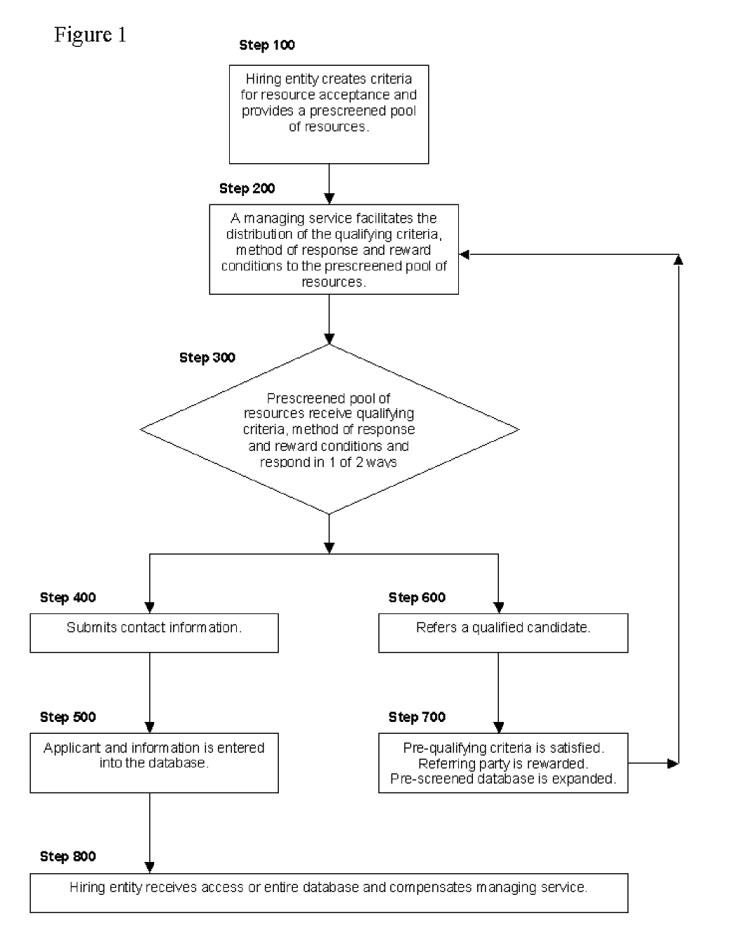

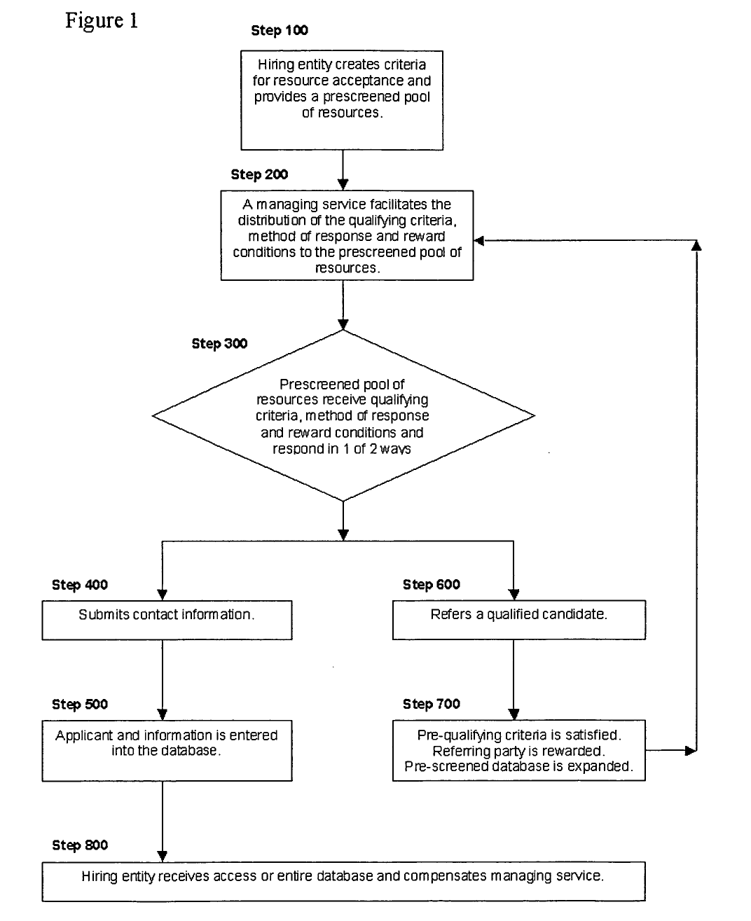

FIG. 1 exhibits a flowchart that will be used to explain the core embodiment of the invention.

In step 100 the method is initiated by a hiring entity that will provide an initial pool of resources, minimum qualifications, desired attributes and reward and payment criteria to a managing service for creation and access to a database that contains resources whose qualifications satisfy the initial parameters. After the resource database parameters have been defined and compensation to the managing service agreed upon, then in step 200 the managing service facilitates the distribution of the opportunity description to the initial pool of resources. It is anticipated that in another embodiment of the invention the hiring entity may utilize a pre-existing pool of resources that has been created by the managing service by means of sorting and classifying resources that have been identified during prior resource searches. In all embodiments of this invention the managing service will contact individuals within an initial pool of resources by utilizing Internet based e-mail that contains the senders identification, any personalized message that the sender may wish to include, the opportunity description, and an opportunity for reward should the recipient refer an acquaintance or associate that would satisfy the minimum qualifications as set forth by the hiring entity.

Step 300 requires a response on the behalf of the contacted party. The received e-mail will contain links, that if activated, will direct the recipient to a web site created by the managing service that contains all the information needed to either apply for the opportunity (step 400), or, refer a qualified associate and qualify for a reward for a referral (step 600). By activating the link contained in the opened e-mail, the recipient will also be transmitting identification data to the managing service. Examples of information that may be transmitted include an SP (Internet Services Provider) address, any personal information associated with that address, a history of previously viewed web sites and other pieces of information that may or may not be included in the database created by the managing service.

Should the initial recipient choose to respond to the offered opportunity for employment (per step 400), the managing services web site would facilitate the choice by accepting contact information from that recipient. Minimum informational requirements may be determined by the hiring entity or the managing entity depending upon the payment structure as defined during step 100.

Step 500 updates the managing entity's database by entering the recipients' information. The database may be sorted or categorized per the hiring entities criteria that may include educational qualifications, salary requirements, geographic location, professional fields of interest, as well as profession-based categories such as research topics of interest, positions/titles held, years of experience, companies worked for, managerial, technical, administrative type categories, sales growth generated in dollars, career successes, or other relevant attributes designated by the recruiter or recruiting firm and other distinguishing characteristics.

Should the recipient not be interested in the job opportunity, step 600 may be selected as an opportunity to be rewarded for referring an associate that may meet the minimum qualifications as set forth by the hiring entity. Such a referral would act as a pre-screening apparatus that would relieve the hiring entity of the costs associated with that process.

Step 700 is similar to step 500 in that the managing entities database is modified with the information provided by the prior recipient. This step also signals the distribution of a reward to the referring party.

With the modification of the database the managing entity will obtain other, potentially qualified resources in which to distribute further e-mails. Thus enhancing the pre-screened resource list to be given to the hiring entity.

Step 800 is the completion of the method and purpose of the invention. Ultimately the hiring entity is in possession of, or has access to a listing of pre-screened resources that have a high probability of meeting the minimum qualifications for the presented opportunity. The satisfaction of this action also signals the compensation to the managing entity by the hiring entity as defined during step 100.

While a system proceeding in accordance with the above examples is preferably implemented over the Internet, it is understood that such a system could also be implemented using telephone text massaging. An advantage of systems of the invention is that once identification information is collected form a particular user, that user may be contacted for a similar resource search if that user fits the minimum qualifications for that opportunity. This greatly improves the quality of the search results. In addition, because the user has provided his or her identification information, it is generally known that the user is a willing participant in resource searches. This further reduces the overall costs of obtaining quality information because resources are not wasted on unwilling participants.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for soliciting a response for employment that comprises:
(a) a recruiting entity for initiating an opportunity for employment that includes an opportunity description, an initial pool of qualified resources, a minimum requirement of qualifications and an agreement for payment of services to a managing entity
(b) a managing entity distributing said opportunity description to an initial pool of resources
(c) Potential resources receiving said package and in response thereto,
1) applying for the opportunity, or
2) referring another qualified potential resource
(d) Accepting a referral that includes said opportunity description, and in response thereto,
(1) recording in a referral database the resource description and the primary referral identifier; and
(2) recording in a referral database the secondary referral identifier; and
(3) rewarding the primary referral identifier; and
(4) distributing said opportunity description to the secondary resource
(e) receiving an indication that a trigging event has occurred with respect to said opportunity description and the resource, and in response thereto,
(1) determine a referral fee according to the related referral-payment information, and
(2) generate information indicating that payment of the referral fee is due.

2. The method of claim 1, wherein the initial pool of resources is provided by the managing entity.

3. A computer readable medium having stored thereon a sequence of instructions which, when executed by a processor, cause the processor to perform functions comprising: A method for soliciting a response for employment that comprises:
(a) distributing a description for employment to a pool of resources that includes an opportunity description, a minimum requirement of qualifications and an agreement for payment for a qualified referral;
(b) receiving identification information from recipient of said description for employment;
(c) receiving second identification information a second qualified resource, the second resource being referred to the processor by the first recipient;
(d) determining whether to receive second resource identification based on the analysis of the second identification information;
(e) accepting a referral that includes a resource description, and in response thereto,
(1) recording in a referral database the resource description and the primary referral identifier; and
(2) recording in a referral database the secondary referral identifier; and
(3) rewarding the primary referral identifier; and
(4) distributing said opportunity package description to the secondary resource
(f) receiving an indication that a trigger event has occurred with respect to said opportunity description and the resource, and in response thereto,
(1) determine a referral fee according to the related referral-payment information, and
(2) generate information indicating that payment of the referral fee is due.

4. The method of claim 3, wherein the pool of resources is provided by the managing entity.
